(19) United States
(12) Patent Application Publication
(10) Pub. No.: US 2014/0146359 A1
(43) Pub. Date: May 29, 2014

(54) IMAGE FORMING APPARATUS AND RECORDING MEDIUM

(71) Applicant: Konica Minolta, Inc., Chiyoda-ku (JP)

(72) Inventors: Takao KUROHATA, Hino-shi (JP); Ryosuke Nishimura, Toyokawa-shi (JP); Jun Kunioka, Okazaki-shi (JP); Shoko Haba, Toyokawa-shi (JP)

(73) Assignee: Konica Minolta, Inc., Chiyoda-ku (JP)

(21) Appl. No.: 14/085,971

(22) Filed: Nov. 21, 2013

(30) Foreign Application Priority Data
Nov. 28, 2012 (JP) 2012-260038

(51) Int. Cl. H04N 1/00

(52) U.S. Cl. CPC H04N 1/00962
USPC 358/1.15

(57) ABSTRACT

Provided is an image forming apparatus that is one of a large number of image forming apparatuses logically connected in a hierarchical structure of multiple levels. The image forming apparatus includes: a state obtaining unit configured to obtain an available processing capacity of each of a plurality of child apparatuses, the plurality of child apparatuses being a plurality of image forming apparatuses on a lower level by one from the image forming apparatus; and a distribution control unit configured to transmit update data to the plurality of child apparatuses, the update data relating to firmware of apparatuses, wherein the distribution control unit determines a distribution order relating to the plurality of child apparatuses based on the available processing capacity of each of the plurality of child apparatuses, and transmits the update data to the plurality of child apparatuses in accordance with the distribution order.

This application is based on Japanese Patent Application No. 2012-260038 filed on Nov. 28, 2012, the contents of which are hereby incorporated by reference.

### BACKGROUND OF THE INVENTION

1. Field of the Invention

The present invention relates to an image forming apparatus such as an MFP (Multi-Functional Peripheral) and a technique relating to such an apparatus.

2. Description of the Background Art

A technique for transmitting update data for a terminal apparatus has been known. For example, Japanese Patent Application Laid-Open No. 2007-334602 discloses a technique for transmitting update data sequentially from a terminal apparatus on an upper level to a terminal apparatus on a lower level in a plurality of terminal apparatuses that are logically connected in a hierarchical structure of multiple levels with an update data distribution apparatus (e.g., a server) being at the top. According to this technique, it is possible to reduce load centralization on an update data distribution apparatus (such as a server).

In the meantime, when updating programs such as firmware for a plurality of image forming apparatuses (such as MFPs), it is preferable to reduce the load on an update data distribution apparatus (such as a server).

Using the technique disclosed in Japanese Patent Application Laid-Open No. 2007-334602, it is possible to reduce the load on the update data distribution apparatus (such as a server).

However, according to the technique disclosed in Japanese Patent Application Laid-Open No. 2007-334602, in distribution of update data from one terminal apparatus in such a hierarchical structure to a plurality of terminal apparatuses on a lower level, a problem stated below may occur when these plurality of terminal apparatuses include a terminal apparatus executing processing with very high load (high-load apparatus).

Specifically, if update processing to the high-load apparatus among these plurality of terminal apparatuses is performed first, it takes an extended period of time to perform update processing for this high-load apparatus, and completion of update processing for this high-load apparatus is significantly delayed. As a result, completion of update processing for a relatively large number of apparatuses including the high-load apparatus among the plurality of terminal apparatuses is delayed.

### SUMMARY OF THE INVENTION

An object, of the present invention is to provide a technique enabling execution of more efficient update processing.

A first aspect of the present invention provides an image forming apparatus that is one of a large number of image forming apparatuses logically connected in a hierarchical structure of multiple levels, and the image forming apparatus includes: a state obtaining unit configured to obtain an available processing capacity of each of a plurality of child apparatuses, the plurality of child apparatuses being a plurality of image forming apparatuses on a lower level by one from the image forming apparatus; and a distribution control unit configured to transmit update data to the plurality of child apparatuses, the update data relating to firmware of apparatuses, wherein the distribution control unit determines a distribution order relating to the plurality of child apparatuses based on the available processing capacity of each of the plurality of child apparatuses, and transmits the update data to the plurality of child apparatuses in accordance with the distribution order.

A second aspect of the present invention provides a non-transitory computer readable recording medium having a program recorded therein, the program causing a computer built within an image forming apparatus that is one of a large number of image forming apparatuses logically connected in a hierarchical structure of multiple levels to execute: (a) a step of obtaining an available processing capacity of each of a plurality of child apparatuses, the plurality of child apparatuses being a plurality of image forming apparatuses on a lower level by one from the image forming apparatus; (b) a step of determining a distribution order relating to the plurality of child apparatuses based on the available processing capacity of each of the plurality of child apparatuses; and (c) a step of transmitting update data to the plurality of child apparatuses in accordance with the distribution order.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating an image forming system according to a first embodiment;

FIG. 2 is a functional block diagram schematically illustrating a configuration of an MFP;

FIG. 3 is a flowchart showing an operation of a parent apparatus;

FIG. 4 is a flowchart showing an operation of a child apparatus;

FIG. 5 is a conceptual diagram illustrating a distribution operation in the image forming system;

FIG. 6 is a table showing available processing capacity of CPU resources;

FIG. 7 is a table showing available processing capacity of network resources;

FIG. 8 is a table showing available processing capacity of memory resources;

FIG. 9 is a conceptual diagram illustrating the distribution operation in the image forming system;

FIG. 10 is a conceptual diagram illustrating the distribution operation in the image forming system;

FIG. 11 is a conceptual diagram illustrating the distribution operation in the image forming system;

FIG. 12 is a conceptual diagram illustrating the distribution operation in the image forming system;

FIG. 13 is a diagram illustrating an image forming system according to a modified example;

FIG. 14 is a flowchart showing an operation of a parent apparatus according to a second embodiment;

FIG. 15 is a flowchart showing the operation of the parent apparatus according to the second embodiment;

FIG. 16 is a flowchart showing an operation of a child apparatus according to the second embodiment;

FIG. 17 is a conceptual diagram illustrating a distribution operation in an image forming system;

FIG. 18 is a conceptual diagram illustrating the distribution operation in the image forming system;

FIG. 19 is a flowchart showing an operation of a parent apparatus according to a third embodiment;

FIG. 20 is a diagram illustrating a setting screen for specifying priorities between a plurality of child apparatuses;

FIG. 21 is a diagram illustrating a setting screen for specifying priorities between a plurality of child apparatuses; and

FIG. 22 is a flowchart showing an operation of a parent apparatus according to a fourth embodiment.

### DESCRIPTION OF THE PREFERRED EMBODIMENTS

Hereinafter, embodiments of the present invention are described with reference to the drawings.

### 1. First Embodiment

<1-1. General Outline of Configuration>

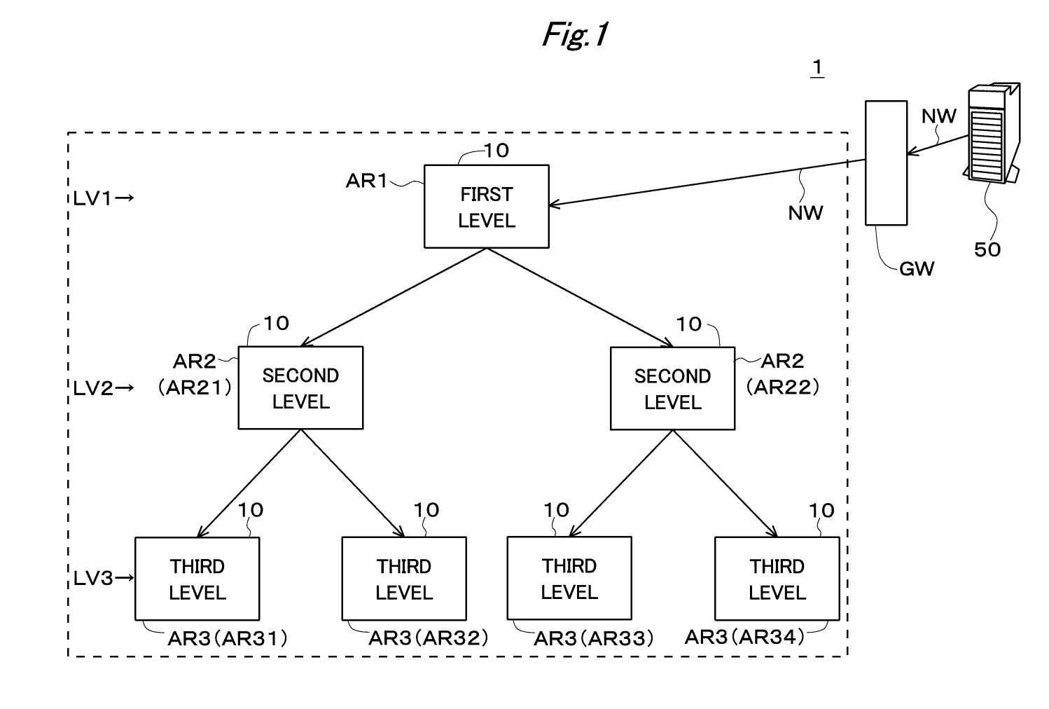

FIG. 1 is a diagram illustrating an image forming system 1 according to a first embodiment. Referring to FIG. 1, the image forming system 1 is provided with a plurality of image forming apparatuses 10. In addition, the image forming system 1 is also provided with a server computer (also simply referred as a server) 50.

The components 10 and 50 in the system 1 are connected through a network NW so as to be able to communicate with each other. The network NW is configured by an LAN (Local Area Network), the Internet, and the like. More specifically, the plurality of image forming apparatuses 10 are connected to an LAN (e.g., corporate network), and the server 50 is connected to a network outside the LAN. Then, the image forming apparatuses 10 and the server 50 are connected through the Internet. The connection to the network NW may be wired connection or wireless connection.

In the system 1, update data (data for updating) for firmware of the image forming apparatuses 10 is distributed from the server computer 50 to each of the image forming apparatuses 10. Accordingly, the system 1 is also referred to as an update data distribution system, and the server 50 is also referred to as an update data distribution apparatus.

In the system 1, a large number of the image forming apparatuses 10 are logically connected in a hierarchical structure of multiple levels (a plurality of levels) with the update data distribution apparatus (server) 50 being at the top.

Here, out of the large number of image forming apparatuses that are logically connected in the hierarchical structure of multiple levels, apparatuses that are on a lower level by one from a predetermined apparatus (level that is immediately below) and in a direct logical connection to the predetermined apparatus are referred to as “child apparatuses” (or transmission target apparatuses) relating to the predetermined apparatus. Further, out of the plurality of image forming apparatuses that are logically connected in the hierarchical structure of multiple levels, an apparatus that is on an upper level by one from the predetermined apparatus (level that is immediately above) and in a direct logical connection to the predetermined apparatus is referred to as a “parent apparatus” (or a transmission source apparatus) relating to the predetermined apparatus.

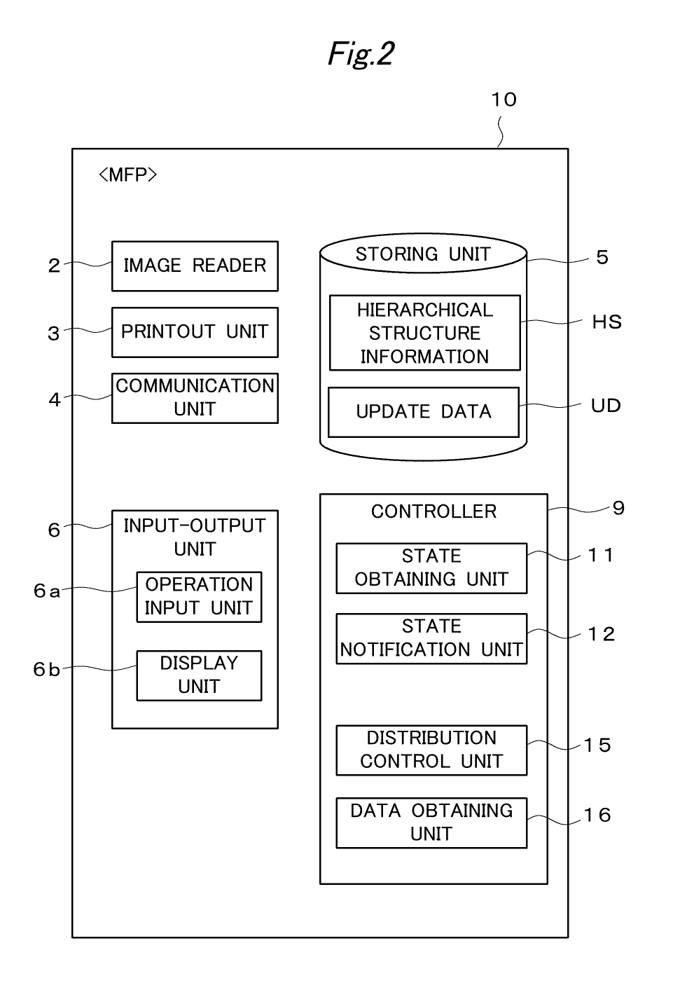

Each of the image forming apparatuses 10 in the system 1 knows a “parent apparatus” (an upper level image forming apparatus in a direct line) and “child apparatuses” (lower level image forming apparatuses in a direct line) of its own. Specifically, each of the image forming apparatuses 10 stores hierarchical structure information HS within a storing unit 5 (FIG. 2) (described later). The hierarchical structure information HS records an identification number and a network address of the “parent apparatus” of this image forming apparatus 10, and identification numbers and network addresses of the “child apparatuses” of this image forming apparatus 10. The hierarchical structure information HS is generated based on an operation by an administrator and the like and stored within the image forming apparatus 10 (the storing unit 5).

Further, in the system 1, update data UD is transmitted sequentially from the image forming apparatuses 10 on a relatively upper level to the image forming apparatuses 10 on a relatively lower level. Specifically, the update data UD is transmitted from the parent apparatus to the child apparatuses, and then from each of the child apparatuses to the child apparatuses of the corresponding child apparatus. The child apparatuses of the corresponding child apparatus are also referred to as grandchild (sub-child) apparatuses. In this manner, the update data UD is sequentially transferred over the plurality of levels (plurality of generations). In the following description, the image forming apparatus 10 on an i-th level LVi is also indicated as an apparatus ARi.

Specifically, as illustrated in FIG. 1, first, the update data UD is transmitted from the server 50 to the image forming apparatus 10 (an apparatus AR1) on a first level (uppermost level) LV1 through a gateway GW.

Then, the image forming apparatus 10 (the apparatus AR1) on the first level LV1 transmits the update data UD to the image forming apparatuses 10 (apparatuses AR2 (specifically, AR21 and AR22)) on a second level LV2 as its “child apparatuses”.

Thereafter, the image forming apparatuses 10 (the apparatuses AR2 (AR21 and AR22)) on the second level LV2 transmit the update data UD to the image forming apparatuses 10 (apparatuses AR3) on a third level LV3 as their respective “child apparatuses”. More specifically, the apparatus AR21 on the second level LV2 transmits the update data UD to the image forming apparatuses 10 (the apparatuses AR3 (AR31 and AR32)) on the third level LV3 as its “child apparatuses”. Similarly, the apparatus AR22 on the second level LV2 transmits the update data UD to the image forming apparatuses 10 (the apparatuses AR3 (AR33 and AR34)) on the third level LV3 as its “child apparatuses”.

In this manner, within the LAN, the update data UD is sequentially transmitted from the image forming apparatuses 10 on the relatively upper level (that is, the “parent apparatus”) to the image forming apparatuses 10 (that is, the “child apparatuses”) on the relatively lower level. With this configuration, the data transfer from the server 50 may be just once that is first performed. Thus, as compared to a case in which each of the image forming apparatuses 10 individually receives the update data UD directly from the server 50, it is possible to reduce the load centralization on the server 50 (update data distribution apparatus).

In this example, the plurality of image forming apparatuses 10 are logically connected in the hierarchical structure of, but not limited to, three levels. The plurality of image forming apparatuses 10 may be logically connected in the hierarchical structure of two levels, for example, or may be logically connected in the hierarchical structure of four or more levels.

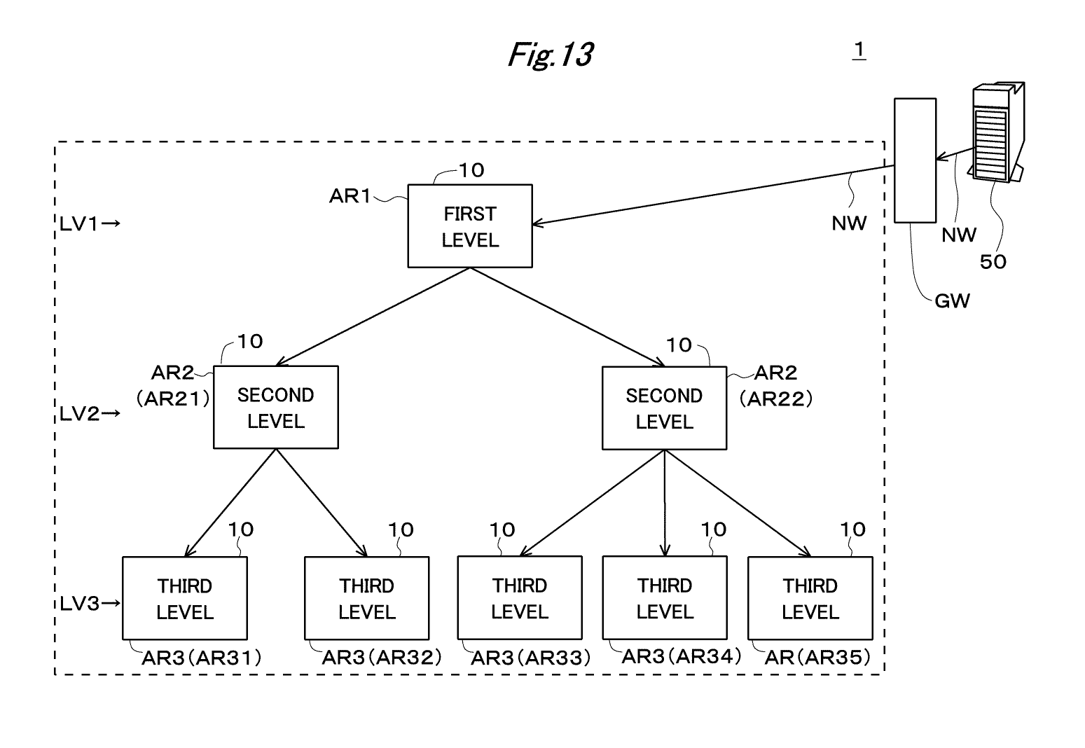

Further, in this example, a single parent apparatus is logically connected with, but not limited to, two child apparatuses. For example, three or more child apparatuses may be logically connected to a single parent apparatus (see FIG. 13). FIG. 13 shows an example in which three “child apparatuses” AR3 (AR33, AR34, and AR35)) are logically connected to a parent apparatus AR22. In addition, not all of the parent apparatuses are required to have a plurality of child apparatuses logically connected thereto. For example, some of the parent apparatuses have only one child apparatus that is logically connected. However, in order to improve a transfer efficiency of the update data UD, it is preferable that branch transfer processing of the update data UD be performed by logically connecting a plurality of “child apparatuses” to a relatively large number of parent apparatuses. In other words, it is preferable that the hierarchical structure be defined such that the number of apparatuses on the relatively lower level is higher than the number of apparatuses on the relatively upper level.

<1-2. Configuration of Image Forming Apparatus 10>

In this embodiment, an MFP (Multi-Functional Peripheral) is described as an example of the image forming apparatus 10.

FIG. 2 is a functional block diagram schematically illustrating a configuration of an MFP 10. It should be noted that the description is given focusing on functional blocks of the MFP 10 on the uppermost level (first level) LV1 (see FIG. 1). The MFPs 10 on the second level and lower have the same configuration.

The MFP 10 is an apparatus (also referred to as a multifunction apparatus) provided with functions such as a scanning function, a copying function, a facsimile function, and a box storage function. Specifically, as illustrated in the functional block diagram in FIG. 2, the MFP 10 is provided with an image reader 2, a printout unit 3, a communication unit 4, the storing unit 5, an input-output unit 6, a controller 9, and the like, and realizes the various functions by multiple operations of these components.

The image reader 2 is a processor that optically reads (i.e., scans) a document placed on a predetermined position of the MFP 10 and generates image data of this document (also referred to as a document image or a scanned image). The image reader 2 is also referred to as a scanner.

The printout unit 3 is an output unit that prints an image on a medium of a variety of types, such as paper, based on data relating to a printing object.

The communication unit 4 is a processor that is able to perform facsimile communication via the public line and the like. Further, the communication unit 4 is also able to perform network communication via the network NW. In the network communication, any of various protocols such as TCP/IP (Transmission Control Protocol/Internet Protocol) can be used, for example. By using such a network communication, the MFP 10 is able to receive or transmit various data from or to a desired target.

The storing unit 5 is configured by a storage apparatus such as a hard disk drive (HDD). The storing unit 5 stores various data. For example, the storing unit 5 stores various setting information (including the hierarchical structure information HS), image data relating to various jobs, and the like. Further, data such as the update data UD relating to firmware (program) PG1 of the MFP 10 is also stored in the storing unit 5.

The input-output unit 6 includes an operation input unit 6a for accepting an input operation to the MFP 10 and a display unit 6b for outputting and displaying various information. The MFP 10 is provided with an operation panel 6c (not shown) having a touch panel (also referred to as a touch screen) configured such that a piezoelectric sensor or the like is embedded in a liquid crystal display panel. The operation panel 6c functions as a part of the operation input unit 6a as well as a part of the display unit 6b.

The controller 9 is a control unit built within the MFP 10 and for controlling the MFP 10 as a whole. The controller 9 is configured as a computer system having a CPU, various semiconductor memories (RAM and ROM), and the like. The controller 9 realizes various processors by a CPU executing a predetermined software program (also referred to as firmware or simply as a program) PG1 stored in an ROM (e.g., EEPROM). It should be noted that the program PG1 may be recorded in a portable recording medium such as a USB memory (that is, various computer readable non-transitory recording medium), and may be installed in the MFP 10 through the recording medium. Alternatively, the program PG1 may be downloaded via the network NW and the like, and then installed in the MFP 10.

As illustrated in FIG. 2, the controller 9 realizes various processors including a state obtaining unit 11, a state notification unit 12, a distribution control unit 15, and a data obtaining unit 16 by executing the program PG1.

The state obtaining unit 11 is a processor for obtaining a condition of available processing capacity (load condition) of a child apparatus 10 from this child apparatus 10, and the state notification unit 12 is a processor for notifying a condition of available processing capacity (load condition) of an own apparatus 10 to a parent apparatus 10.

Specifically, the state obtaining unit 11 of one apparatus (the parent apparatus) (e.g., the apparatus AR1 on the first level LV1) transmits a notification request (inquiry command) RQ for available processing capacity to a child apparatus (the apparatus AR2 on the second level), and the state notification unit 12 of this child apparatus (the apparatus AR2 on the second level) notifies the parent apparatus (the apparatus AR1 on the first level) of an available processing capacity CP of the own apparatus (the apparatus AR2 on the second level). As a result, the state obtaining unit 11 of the parent apparatus (the apparatus AR1 on the first level) obtains the available processing capacity CP of the child apparatus (the apparatus AR2 on the second level). Similarly, the same operation is executed for the apparatuses on further lower levels. For example, the state obtaining unit 11 of the apparatus on the second level (the new parent apparatus AR2) transmits the notification request (inquiry command) RQ for available processing capacity to its child apparatus (the apparatus AR3 on the third level), the state notification unit 12 of this child apparatus (the apparatus AR3 on the third level) notifies its parent apparatus (the apparatus AR2 on the second level) of the available processing capacity CP of the own apparatus (the apparatus AR3 on the third level). As a result, the state obtaining unit 11 of the parent apparatus (the apparatus AR2 on the second level) obtains the available processing capacity CP of the child apparatus (the apparatus AR3 on the third level).

Further, the distribution control unit (also referred to as an update data transmit control unit) 15 is a processor for controlling an operation for distributing the update data to the child apparatuses, and the data obtaining unit (also referred to as an update data reception control unit) 16 is a processor for receiving the update data from the parent apparatus.

Specifically, the data obtaining unit 16 of one apparatus further receives the update data from its parent apparatus. For example, the data obtaining unit 16 of the apparatus AR1 on the first level (parent apparatus) further receives the update data from its parent apparatus (an apparatus on a zeroth level (the server 50)). Then, the distribution control unit 15 of the parent apparatus (the apparatus on the first level) AR1 distributes the update data UD obtained from the parent apparatus (the apparatus on the zeroth level (the server 50)) to the child apparatuses (the apparatuses on the second level) AR2. The respective data obtaining units 16 of the child apparatuses (the apparatuses on the second level) AR2 receive the update data UD from the parent apparatus (the apparatuses on the first level) AR1.

Similarly, the same operation is executed for the apparatuses on the further lower level. For example, when the data obtaining unit 16 of the apparatus AR2 on the second level (the new parent apparatus) further receives the update data from its parent apparatus (the apparatus on the first level) AR1, the distribution control unit 15 of the new parent apparatus (the apparatus on the second level) AR2 distributes the update data UD obtained from its parent apparatus AR1 (the apparatus on the first level) to child apparatuses (the apparatuses on the third level) AR3 of the apparatus AR2. Then, the respective data obtaining units 16 of these child apparatuses (the apparatuses on the third level) AR3 receive the update data UD from its parent apparatus (the apparatus on the second level) AR2.

Moreover, as will be described later, in particular, the distribution control unit 15 of the parent apparatus selects (determines) a child apparatus, to which the update data UD is preferentially transmitted, out of the plurality of child apparatuses based on load conditions (available processing capacity) of these child apparatuses, and transmits the update data UD preferentially to the selected child apparatus. With this, it is possible to improve an efficiency of the operation for distributing the update data UD.

<1-3. Operation>

Next, operations of the system 1 will be described in further detail.

As described above, the plurality of image forming apparatuses 10 are logically connected in multiple levels. Then, after the update data UD is transmitted from the server 50 to the image forming apparatus 10 (AR1) on the uppermost level (first level) LV1, the update data is sequentially transmitted from terminal apparatuses on relatively upper levels to terminal apparatuses on relatively lower levels.

Hereinafter, first, an operation in which the update data UD is further transferred from the image forming apparatus 10 (the parent apparatus AR1) on the first level LV1 to the image forming apparatuses 10 (the child apparatuses AR2) on the second level LV2 will be described.

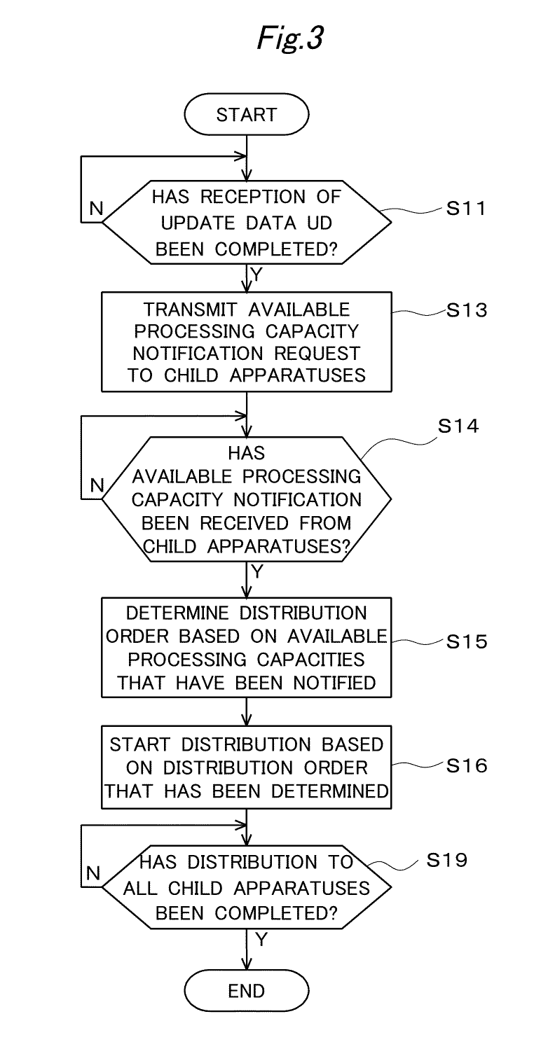

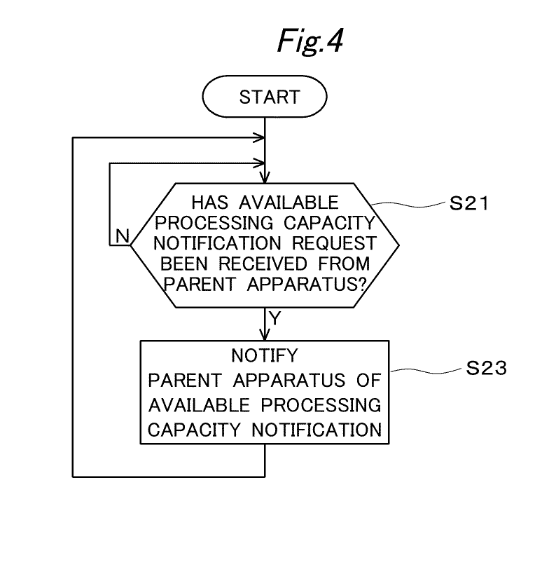

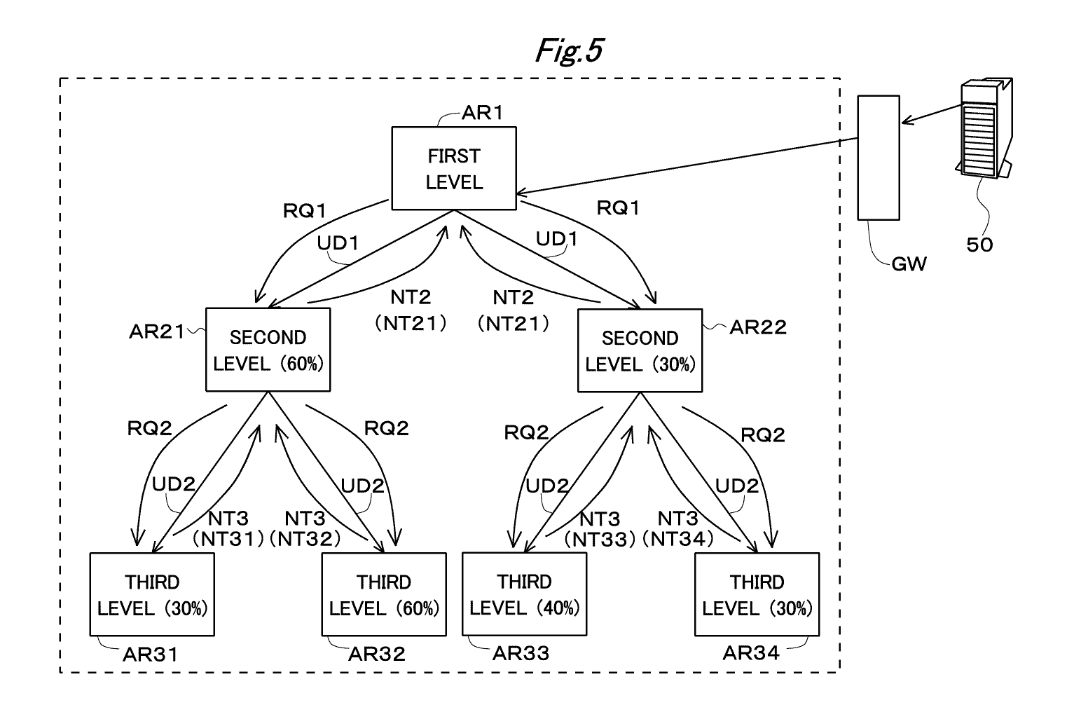

FIG. 3 is a flowchart showing an operation of a source apparatus of the update data UD (parent apparatus), and FIG. 4 is a flowchart showing an operation of a destination apparatus of the update data UD (child apparatus). Further, FIG. 5 is a conceptual diagram illustrating the distribution operation in the image forming system.

First, in Step S11, the image forming apparatus 10 on the first level LV1 (the apparatus AR1) as the parent apparatus determines whether or not the reception of the update data UD from the server 50 has been completed.

When it is determined that the reception of the update data UD by the own apparatus has been completed, the process proceeds to Step S13. In Step S13, the parent apparatus (apparatus on a relatively upper level) AR1 transmits the notification request RQ (RQ1) for the available processing capacity CP (also referred to as a notification request of a load condition) to the image forming apparatuses AR2 (the child apparatuses AR21 and AR22 of the image forming apparatus AR1) (also see FIG. 5).

On the other hand, as illustrated in FIG. 4, each of the child apparatuses AR21 and AR22 receives the notification request RQ1 from the parent apparatus AR1 (Step S21). In response to the reception, the process for the child apparatuses AR21 and AR22 proceeds from Step S21 to Step S23. Then, each of the child apparatuses AR21 and AR22 obtains the available processing capacity CP (specifically, an available processing capacity index (later described)) of the own apparatus (AR21 or AR22) and notifies the parent apparatus AR1 of the available processing capacity CP (Step S23). In other words, each of the child apparatuses AR21 and AR22 obtains the load condition of the own apparatus and notifies the parent apparatus AR1 of the load condition.

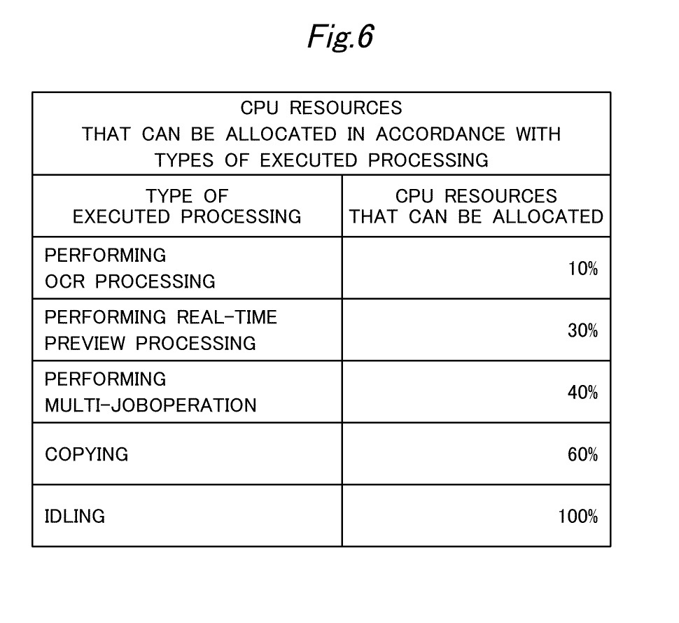

FIG. 6 is a table showing available processing capacity relating to CPU resources of the image forming apparatus 10, and more specifically, an index value (also referred to as an available processing capacity index) corresponding to CPU resources allocated to (available for) a new processing. FIG. 6 shows relation between types of processings that are being executed (type of executed processing) and the available processing capacities in the image forming apparatus 10.

In an upper low of the table shown in FIG. 6, it is shown that when an “OCR processing” is executed in the image forming apparatus 10, 90% of the CPU resources are used (very high load condition) and the available processing capacity is “10%”. Similarly, it is shown that when a “real-time preview processing” is executed in the image forming apparatus 10, 70% of the CPU resources are used and the available processing capacity is “30%”. Further, it is shown that when a “copying processing” is executed in the image forming apparatus 10, 40% of the CPU resources are used, and the available processing capacity is “60%”. It is also shown that when the image forming apparatus 10 is in an “idling” state, 0% of the CPU resources are used and the available processing capacity is “100%”.

In this embodiment, the available processing capacities of the image forming apparatuses 10 are determined based on the available processing capacities of the CPU resources (Step S23). For example, when the child apparatus AR21 is executing the “copying processing”, it is determined that the available processing capacity of the child apparatus AR21 (specifically, the available processing capacity index) is “60%”. Further, when the child apparatus AR22 is executing the “real-time preview processing”, it is determined that the available processing capacity of the child apparatus AR22 is “30%”. Then the child apparatuses AR21 and AR22 notify the parent apparatus AR1 of available processing capacities “60%” and “30%” respectively of the apparatuses AR21 and AR22 (Step S23).

Thereafter, the parent apparatus AR1 obtains available processing capacity notification NT2 returned from each of the child apparatuses AR2 (see also FIG. 5). In Step S14, when it is determined that the available processing capacity notifications NT21 and NT22 from all of the child apparatuses AR21 and AR22 have been received, the process proceeds to Step S15.

In Step S15, the parent apparatus AR1 determines a distribution order of the update data UD (transmission order), based on the available processing capacities of the child apparatuses notified by the available processing capacity notifications NT2 (NT21 and NT22). Specifically, the distribution control unit 15 of the parent apparatus AR1 determines an apparatus with highest available processing capacity out of the plurality of child apparatuses AR21 and AR22 to which the update data UD has not been transmitted to be a “prioritized destination apparatus”. For example, when the available processing capacity of the child apparatus AR21 is 60% and the available processing capacity of the child apparatus AR22 is 30% as shown in FIG. 5, the child apparatus AR21 having relatively higher available processing capacity is determined to be the “prioritized destination apparatus”. In other words, the child apparatus AR21 is determined to be a destination apparatus with a first priority. Further, the child apparatus AR22 is determined to be a destination apparatus with a second priority. In this manner, a distribution order of all of the child apparatuses AR21 and AR22 (priorities for distribution destination) is determined.

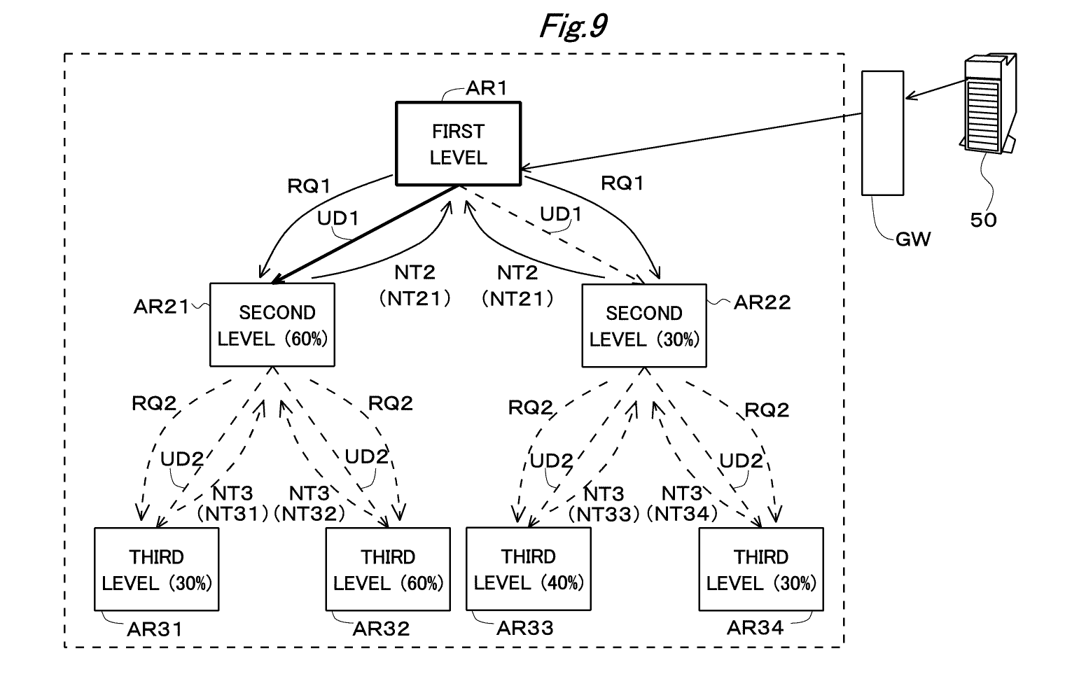

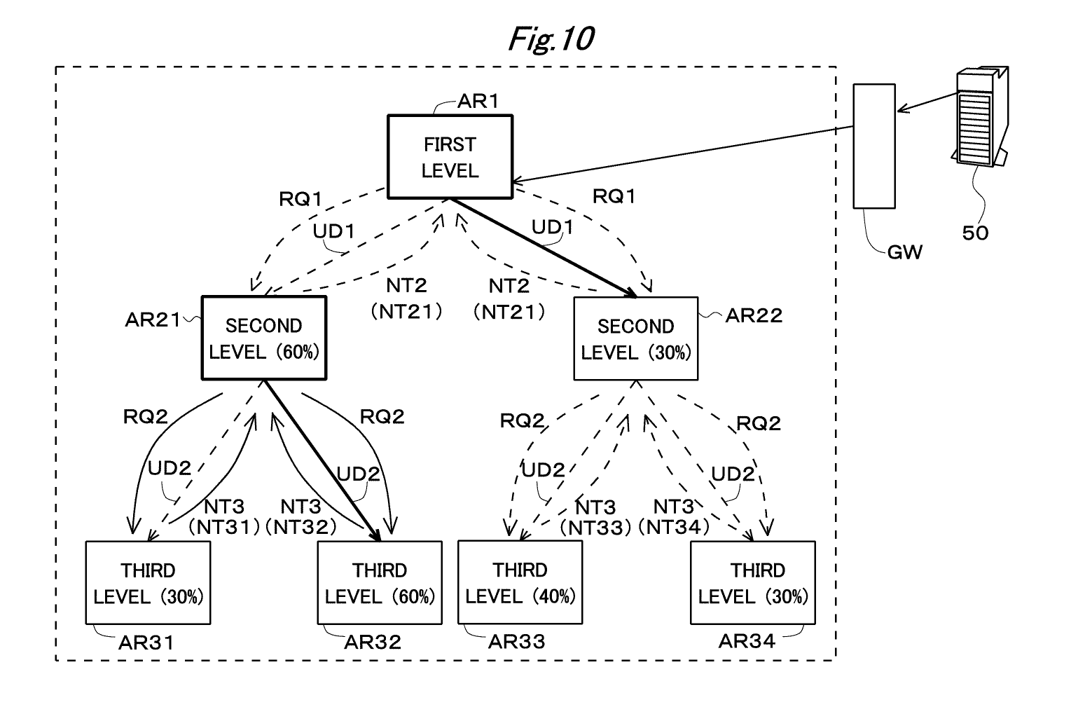

Then, in Step S16, the distribution control unit 15 of the parent apparatus AR1 transmits the update data UD to the plurality of child apparatuses AR21 and AR22 in accordance with the distribution order (also referred to as a transmission order). Specifically, first, the update data UD (UD1) is transmitted to the prioritized destination apparatus (the destination apparatus with a first priority) AR21 out of the plurality of child apparatuses AR21 and AR22 preferentially to (before) the other apparatus (AR22) (see also FIG. 9). Then, after transmission of the update data UD to the child apparatus AR21 with a first priority has been completed, the update data UD is transmitted to the child apparatus AR22 with a second priority (see also FIG. 10).

Upon determination that the distribution of the update data UD to all of the child apparatuses AR21 and AR22 has been completed in Step S19, the operation in the parent apparatus AR1 shown in FIG. 3 ends.

In this manner, the transfer operation from the image forming apparatus AR1 on the first level to the image forming apparatuses AR2 on the second level is completed (see FIG. 5).

Similarly, the transfer operation from the image forming apparatuses AR2 on the second level to the image forming apparatuses AR3 on the third level is executed (see FIG. 5).

Specifically, the transfer operation from the image forming apparatus AR21 on the second level to the image forming apparatuses AR31 and AR32 on the third level is executed, and the transfer operation from the image forming apparatus AR22 on the second level to the image forming apparatuses AR33 and AR34 on the third level is executed.

At this time, the image forming apparatus AR21 on the second level serves as a parent apparatus of the image forming apparatuses AR31 and AR32 on the third level, and the image forming apparatus AR22 on the second level serves as a parent apparatus of the image forming apparatuses AR33 and AR34 on the third level. Conversely, the image forming apparatuses AR31 and AR32 on the third level serve as child apparatuses of the image forming apparatus AR21 on the second level, and the image forming apparatuses AR33 and AR34 on the third level serve as child apparatuses of the image forming apparatus AR22 on the second level.

For example, the transfer operation from the image forming apparatus AR21 on the second level to the image forming apparatuses AR31 and AR32 on the third level is performed in the following manner.

First, in Step S11, the image forming apparatus 10 on the second level LV2 (the apparatus AR21) as a parent apparatus determines whether or not the reception of the update data UD from the image forming apparatus 10 (an additional parent apparatus AR1) on the first level LV1 has been completed.

When it is determined that the reception of the update data UD by the own apparatus has been completed, the process proceeds to Step S13. In Step S13, the parent apparatus (apparatus on a relatively upper level) AR21 transmits the notification request RQ (RQ2) for the available processing capacity to the image forming apparatuses AR3 (the child apparatuses AR31 and AR32 of the image forming apparatus AR2) (also see FIG. 5).

On the other hand, when each of the child apparatuses AR31 and AR32 receives the notification request RQ2 from the parent apparatus AR2 as illustrated in FIG. 4, the process proceeds from Step S21 to Step S23. Then, each of the child apparatuses AR31 and AR32 obtains the available processing capacity (specifically, available processing capacity status) of the own apparatus (AR31 or AR32) and notifies the parent apparatus AR2 of the available processing capacity.

Thereafter, the parent apparatus AR21 obtains available processing capacity notifications NT3 (NT31 and NT32) returned from each of the child apparatuses AR31 and AR32. In Step S14, when it is determined that the available processing capacity notifications NT31 and NT32 from all of the child apparatuses AR31 and AR32 have been received, the process proceeds to Step S15.

In Step S15, the parent apparatus AR21 determines a distribution order of the update data UD, based on all of the available processing capacity notifications NT31 and NT32 that has been received. Specifically, the distribution control unit 15 of the parent apparatus AR21 determines an apparatus with highest available processing capacity out of the plurality of child apparatuses AR31 and AR32 to which the update data UD has not been transmitted to be a “prioritized destination apparatus”. For example, when the available processing capacity of the child apparatus AR31 is 30% and the available processing capacity of the child apparatus AR32 is 60% as shown in FIG. 5, the child apparatus AR32 having relatively higher available processing capacity is determined to be the “prioritized destination apparatus”. In other words, the child apparatus AR32 is determined to be a destination apparatus with a first priority. Further, the child apparatus AR31 is determined to be a destination apparatus with a second priority. In this manner, a distribution order of all of the child apparatuses AR31 and AR32 (priorities for distribution destination) is determined.

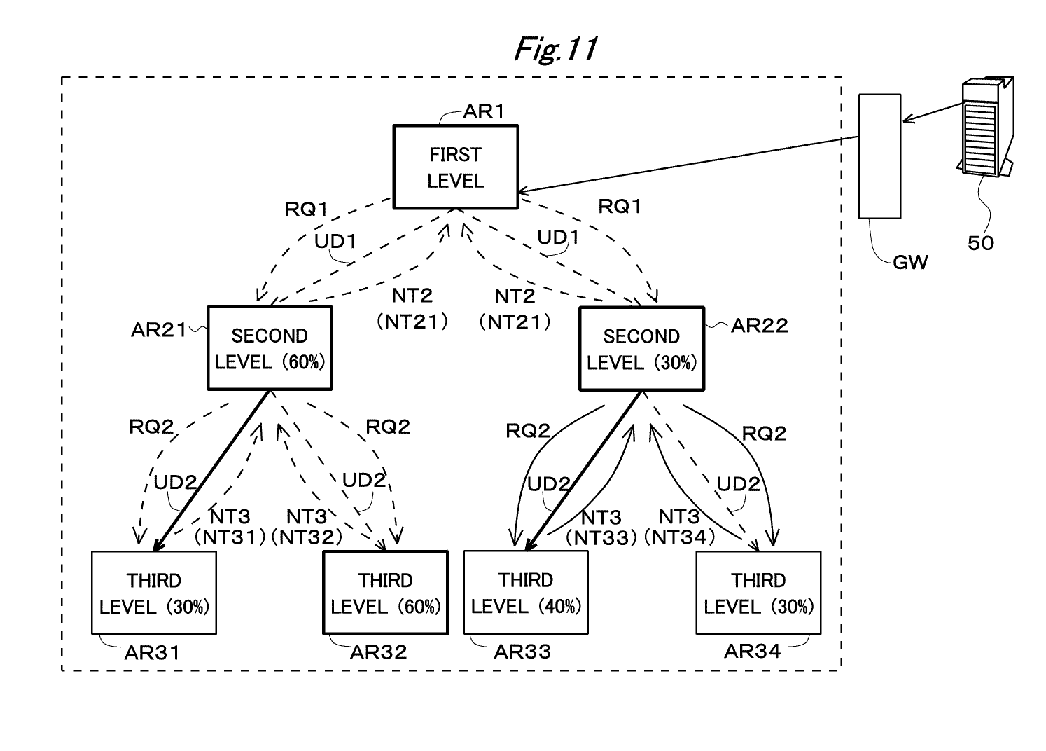

Then, in Step S16, the distribution control unit 15 of the parent apparatus AR2 transmits the update data UD to the plurality of child apparatuses AR31 and AR32 in accordance with the distribution order. Specifically, first, the update data UD is transmitted to the prioritized destination apparatus (the destination apparatus with a first priority) AR32 out of the plurality of child apparatuses AR31 and AR32 preferentially to (before) the other apparatus (AR31) (see also FIG. 10). Then, after the transmission of the update data UD to the child apparatus AR32 with a first priority has been completed, the update data UD is transmitted to the child apparatus AR31 with a second priority (see also FIG. 11).

Upon completion of the distribution of the update data UD to all of the child apparatuses AR31 and AR32, the operation in the parent apparatus AR21 shown in FIG. 3 ends.

In this manner, the transfer operation from the image forming apparatus AR21 on the second level to the image forming apparatuses AR31 and AR32 on the third level is completed (see FIG. 5).

Similarly, the transfer operation from the image forming apparatus AR22 on the second level to the image forming apparatuses AR33 and AR34 on the third level is executed (see FIG. 5).

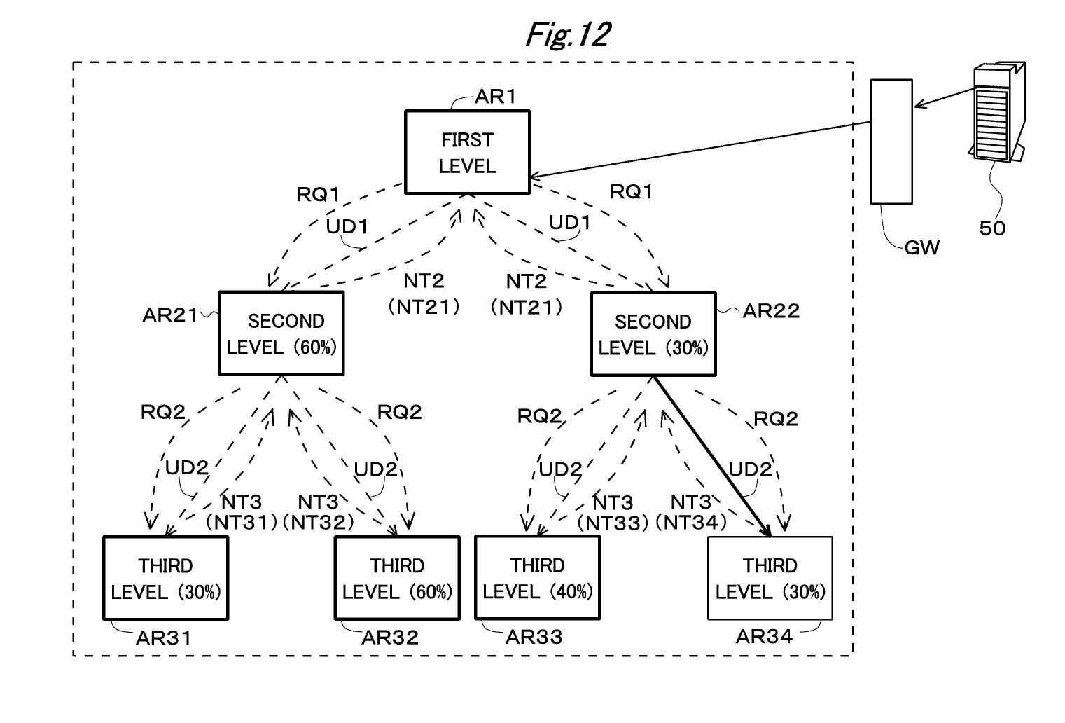

Here, upon completion of the transfer of the update data UD from the apparatus AR1 to the apparatus AR21 (see FIG. 9), the transfer processing of the update data UD from the apparatus AR1 to the apparatus AR22 and the transfer processing of the update data UD from the apparatus AR21 to apparatus AR32 start substantially at the same time (see FIG. 10). As a result, in particular, the update data UD may be distributed to the apparatus AR32 out of the apparatuses on the third level relatively early. In addition, additional transfer processing may be executed in an appropriate order, although this depends on the load status of the apparatuses AR22 and AR21. For example, the transfer processing of the update data UD from apparatus AR21 to the apparatus AR31 (see FIG. 11), the transfer processing of the update data UD from the apparatus AR22 to the apparatus AR33 (see FIG. 11), and the transfer processing of the update data UD from the apparatus AR22 to the apparatus AR34 (see FIG. 12) may be executed in the stated order.

In the example described above, the parent apparatus AR1 executes the transmission processing of the update data sequentially from the child apparatus AR21 with highest available processing capacity (lowest load) out of the plurality of child apparatuses AR21 and AR22.

With this configuration, it is possible to complete the data transmission processing to the child apparatus AR21 with highest available processing capacity relatively early. Therefore, as compared to a case in which the data transmission processing is executed from a child apparatus with lowest available processing capacity (highest load) (e.g., the child apparatus AR22), it is possible to complete data transmission processing to one child apparatus out of a plurality of child apparatuses relatively early. Further, thereafter, the data transmission processing to a child apparatus with relatively high available processing capacity is sequentially executed. Therefore, it is possible to complete data transmission processing to a larger number of child apparatuses (e.g., the apparatus AR21, AR32, . . . ) relatively early. In other words, it is possible to increase the number of apparatuses that have completed the reception of the update data at any point before completing the update, as compared to a case in which the update processing is first executed to a high-load apparatus out of the plurality of image forming apparatuses 10.

Further, the load status of the child apparatus AR22 which has been high at a point of starting distribution to the child apparatus AR21 with low load status may often take an upturn (decrease of the load), as the executed processing for this the child apparatus AR22 may have been completed during the distribution processing to the child apparatus AR21. Therefore, by performing the update data transmission processing first to the child apparatus AR21, and then to the child apparatus AR22, it is possible to reduce the time required for the update data processing to the child apparatus AR22. Accordingly, the distribution operation may be performed in a highly efficient manner.

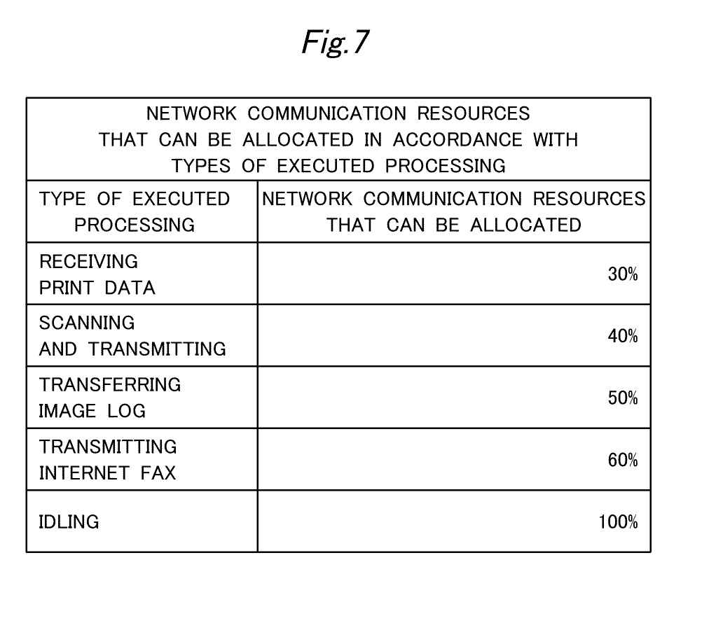

In the above description, the available processing capacities of the image forming apparatuses 10 are determined based on, but not limited to, the available processing capacity indices corresponding to the CPU resources (Step S15). The available processing capacities of the image forming apparatuses 10 may be determined, for example, based on available processing capacities of network communication resources of the image forming apparatuses 10 (see FIG. 7).

FIG. 7 is a table for such an example. FIG. 7 is a table showing available processing capacity relating to network communication resources (network communication speed) of the image forming apparatus 10, and more specifically, an index value (available processing capacity index) corresponding to network communication resources allocated to (available for) a new processing in the image forming apparatus 10. FIG. 7 shows a relation between processings that are being executed and the available processing capacities.

In an upper low of the table shown in FIG. 7, it is shown that when a “print data reception” processing is executed in the image forming apparatus 10, 70% of the network resources are used and the available processing capacity is “30%”. Similarly, it is shown that when a “scanned image transmission” processing is executed in the image forming apparatus 10, 60% of the network resources are used and the available processing capacity is “40%”.

For example, it may be configured such that when the child apparatus AR22 is executing the “print data reception” processing, it is determined that the available processing capacity of the child apparatus AR22 is “30%”, and the child apparatus AR22 notifies the parent apparatus AR1 of available processing capacity “30%” of the apparatus AR22.

Alternatively, the available processing capacities of the image forming apparatuses 10 may be determined based on available processing capacities of memory capacities of the image forming apparatuses 10.

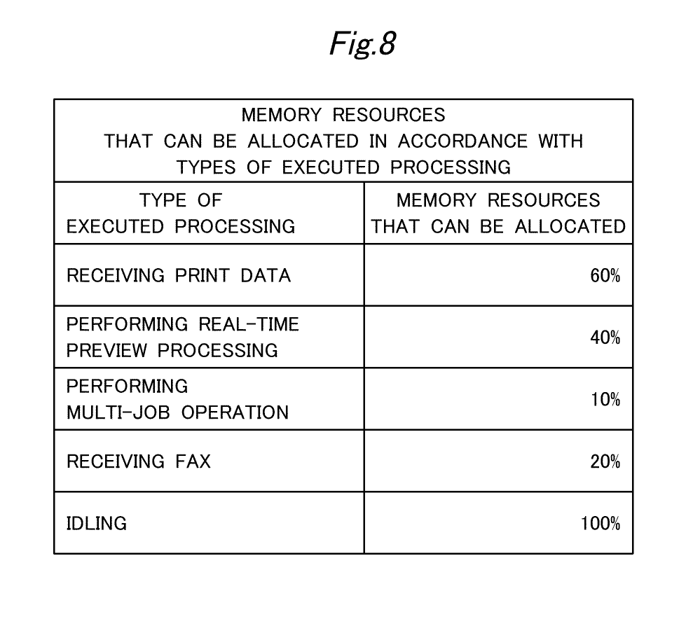

FIG. 8 is a table for such an example. FIG. 8 is a table showing available processing capacity relating to memory resources (memory capacity) of the image forming apparatus 10. FIG. 8 shows a relation between processings that are being executed and the available processing capacities.

FIG. 8 is a table for such an example. FIG. 8 is a table showing available processing capacity relating to memory resources (memory capacity) of the image forming apparatus 10, and more specifically, an index value (available processing capacity index) corresponding to memory resources allocated to (available for) a new processing in the image forming apparatus 10. FIG. 8 shows relation between processings that are being executed and the available processing capacities.

In an upper low of the table shown in FIG. 8, it is shown that when the “print data reception” processing is executed in the image forming apparatus 10, 40% of the memory resources are used and the available processing capacity is “60%”. Similarly, it is shown that when the “real-time preview processing” is executed in the image forming apparatus 10, 60% of the memory resources are used and the available processing capacity is “40%”. Further, it is shown that when the image forming apparatus 10 is “receiving FAX”, 80% of the memory resources are used and the available processing capacity is “20%”.

For example, it may be configured such that when the child apparatus AR21 is executing the “print data reception processing”, it is determined that the available processing capacity of the child apparatus AR21 is “60%”, and the child apparatus AR21 notifies the parent apparatus AR1 of available processing capacity “60%” of the apparatus AR21.

Alternatively, the available processing capacities of the image forming apparatus 10 may be determined based on index values corresponding to a plurality of elements including the available CPU resources, the available network communication resources, the available memory resources, and the like.

Specifically, the available processing capacity of the image forming apparatus 10 may be obtained as a value corresponding to the lowest processing capability out of the index values respectively corresponding to the plurality of elements (the lowest one of the plurality of available processing capacity indices). For example, in a case in which the available processing capacity based on the CPU resources is “60%”, the available processing capacity based on the network communication resources is “40%”, and the available processing capacity based on the memory resources is “30%”, the available processing capacity “30%”, which is the lowest of these, may be obtained as the available processing capacity of the image forming apparatus 10.

Alternatively, the available processing capacity of the image forming apparatus 10 may be obtained as a weighted average efficiency of the index values respectively corresponding to the plurality of elements. For example, a case is assumed in which the available processing capacity based on the CPU resources is “60%”, the available processing capacity based on the network communication resources is “40%”, and the available processing capacity based on the memory resources is “30%”. In this case, a value “42.5%” obtained by executing weighted average to these index values in a weighted proportion of 1:2:1 (=(60%+40%*2+30%)/4) may be obtained as the available processing capacity of the image forming apparatus 10.

### 2. Second Embodiment

A second embodiment is a modified example of the first embodiment. The following description focuses on differences from the first embodiment.

In the second embodiment, a parent apparatus does not execute a transmission operation of the update data UD to a child apparatus if the available processing capacity of this child apparatus is lower than a predetermined level. The second embodiment is different from the first embodiment in this point.

Further, in the second embodiment, each child apparatus notifies its parent apparatus of the available processing capacity of the own apparatus (child apparatus) in accordance with conditions of this child apparatus, in addition to notification to its parent apparatus of the available processing capacity of the own apparatus (child apparatus) in response to the notification request RQ from the parent apparatus. The second embodiment is also different from the first embodiment in this point.

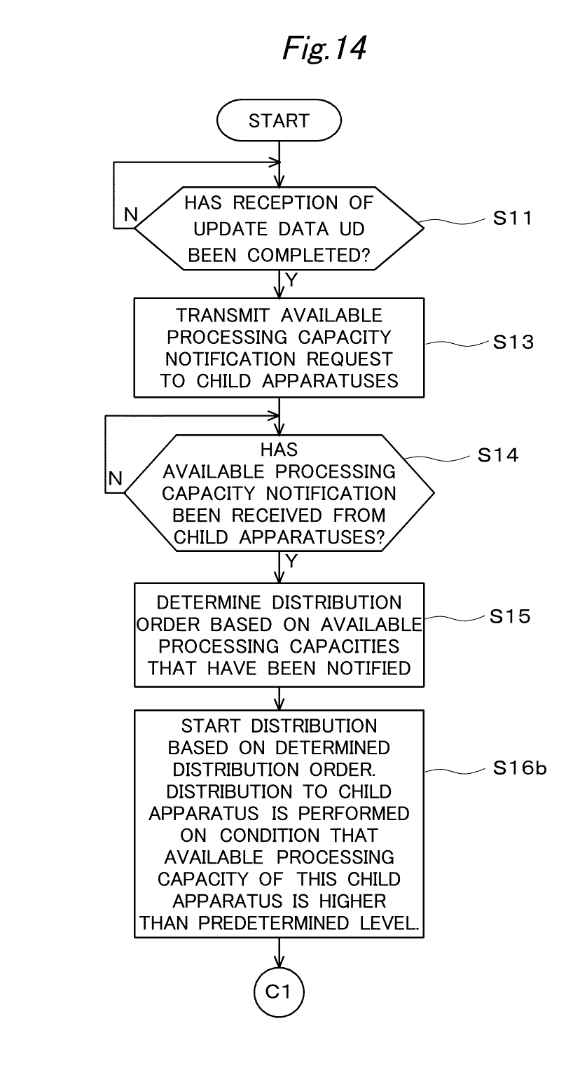

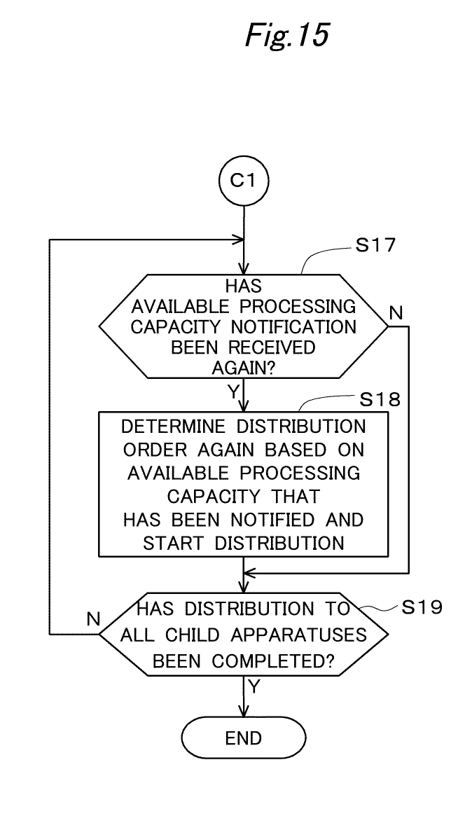

FIG. 14 and FIG. 15 are flowcharts according to the second embodiment. In Step S16 (S16b) in FIG. 14 and Step S18 in FIG. 15, the distribution operation is started on condition that the available processing capacity of the child apparatus is higher than a predetermined reference value RV1. These steps are different from Step S16 in FIG. 3 in this point.

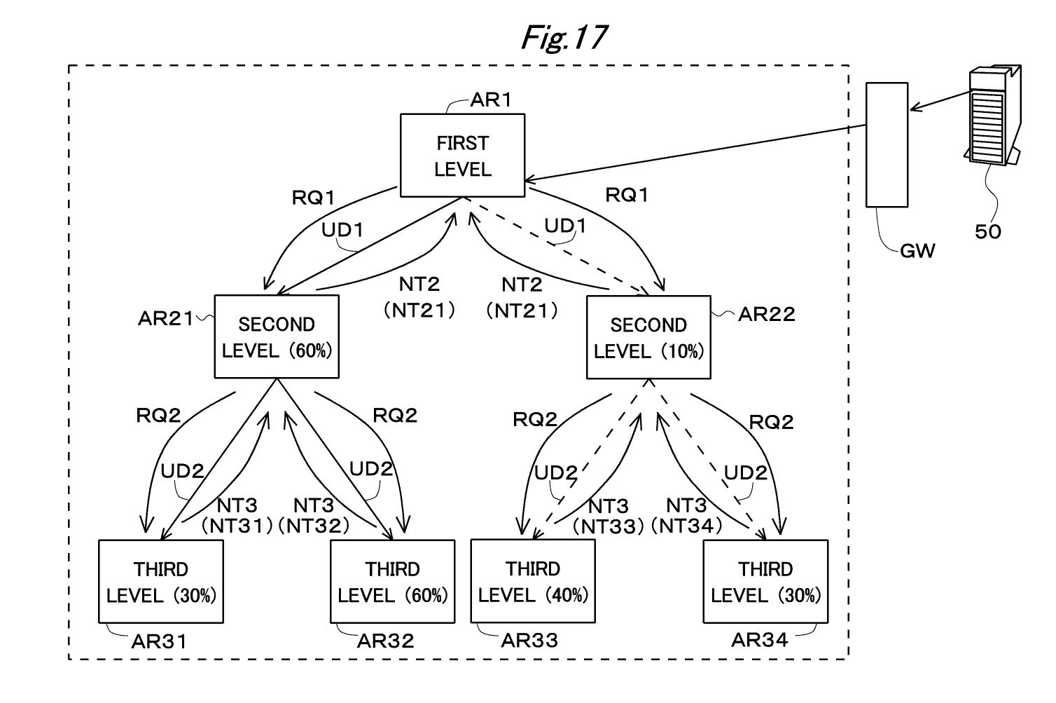

For example, a case is assumed in which as illustrated in FIG. 17, the available processing capacity of the child apparatus AR21 is “60%” and the available processing capacity of the child apparatus AR22 is “10%” at one point.

Similarly to the first embodiment, in this case, it is determined that the child apparatus AR21 has a first priority in the distribution order, and the child apparatus AR22 has a second priority in the distribution order (Step S15).

Then, in Step S16b, it is determined that the available processing capacity “60%” of the child apparatus AR21 is higher than the predetermined level (e.g., “20%” (=the reference value RV1)), and similarly to the first embodiment, the update data UD is transmitted from the parent apparatus AR1 to the child apparatus AR21.

However, after the completion of the transmission to the child apparatus AR21, the parent apparatus AR1 determines that the available processing capacity “10%” of the child apparatus AR22 is lower than the reference value RV1 (“20%”), and the transmission of the update data UD from the parent apparatus AR1 to the child apparatus AR22 is suspended.

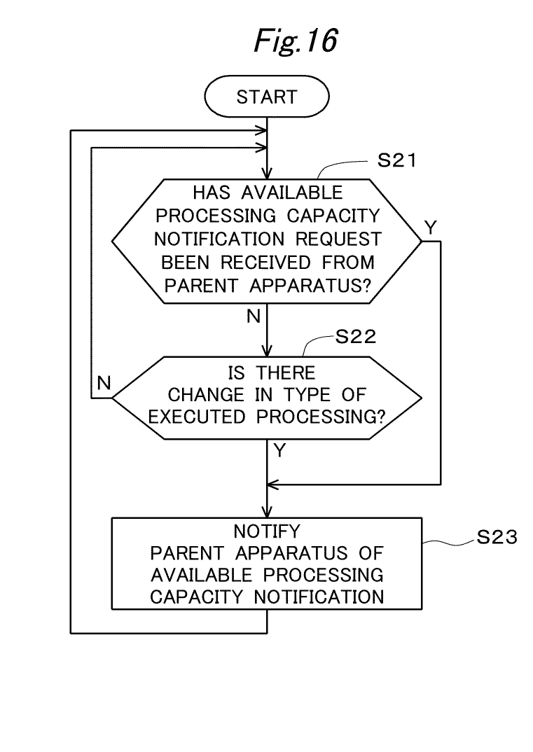

On the other hand, each child apparatus executes an operation shown in FIG. 16 in place of the operation in FIG. 4.

Specifically, as shown in FIG. 16, in Step S22, the process of the child apparatus proceeds to Step S23 also when the type of executed processing (execution state) of the child apparatus changes, and the child apparatus executes an operation for notifying the parent apparatus of the available processing capacity of the own apparatus. For example, when the execution state of the child apparatus AR22 changes from “OCR processing” to “idling”, the child apparatus AR22 notifies the parent apparatus AR1 of the available processing capacity of the own apparatus AR22 increasing from “10%” to “100%”. In other words, the child apparatus AR22 notifies the parent apparatus AR1 that the available processing capacity of the own apparatus AR22 after the execution state changes is “100%”.

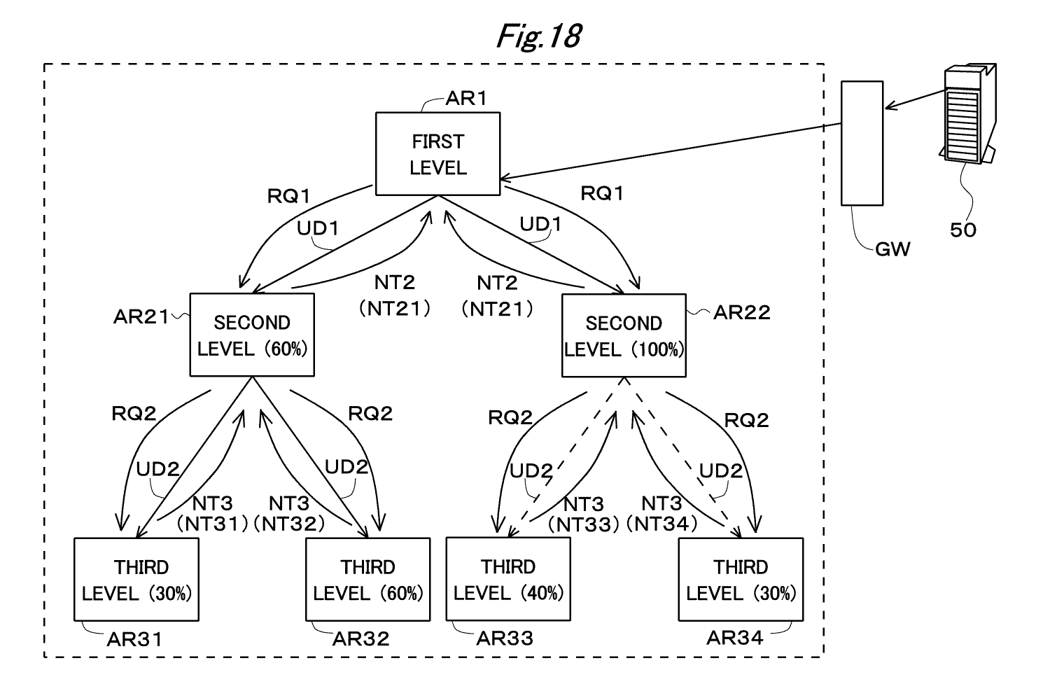

Then, the process of the parent apparatus AR1 proceeds to Step S17 (FIG. 15), and the parent apparatus AR1 again receives the available processing capacity notification NT2 (NT22) from the child apparatus AR22. Thereafter, the parent apparatus AR1 determines the distribution order between apparatuses to which transmission has not been executed out of the destination apparatuses (transmission target apparatuses) (specifically, apparatuses, out of the plurality of child apparatuses, to which transmission of the update data UD has not been started) based on the available processing capacity notified by the available processing capacity notification NT22, and starts the distribution operation in accordance with this distribution order (Step S18). For example, the parent apparatus AR1 determines the child apparatus AR22 that remains to be the next distribution destination. Further, on condition that the available processing capacity of the child apparatus AR22 is higher than the predetermined level, the parent apparatus AR1 executes the transmission operation of the update data UD to the child apparatus AR22 (Step S18). Thereafter, when it is determined that the transmission to all of the child apparatuses has been completed, the operation in FIG. 15 ends (Step S19). In this manner, after the suspension of the transmission operation described above, when it is determined that the available processing capacity of the child apparatus AR22 increases up to a level (e.g., “100%”) higher than the predetermined level (e.g., 20%) (see FIG. 18), the transmission processing of the update data UD from the parent apparatus AR1 to the child apparatus AR22 is executed.

At this time, if the communication processing of the update data UD is further executed when the available processing capacity of the child apparatus AR22 is lower than the predetermined reference value RV1 (e.g., 20%), there is a case in which the processing efficiency of the other processing currently being executed by the child apparatus AR22 (e.g., print data reception job) decreases. In particular, when the available processing capacity of the child apparatus AR22 is lower, if the other processing currently being executed by the child apparatus AR22 and the communication processing of the update data UD use common hardware of various types (e.g., a common communication port, and the like), the processing efficiency of the other processing currently being executed often drops to a large degree.

On the other hand, in this second embodiment, when the available processing capacity of the child apparatus AR22 is lower than the predetermined reference value RV1, the transmission operation of the update data UD to the child apparatus AR22 is not executed. With this, it is possible to prevent a significant drop of efficiency of the processing that is being executed by the child apparatus AR22.

Further, similarly to the first embodiment, the parent apparatus AR1 executes the transmission processing of the update data sequentially from the child apparatus AR21 with highest available processing capacity (lowest load) out of the plurality of child apparatuses AR21 and AR22. Accordingly, it is possible to complete the data transmission processing to one of the plurality of child apparatuses early on.

In this manner, it is possible to prevent a significant drop of efficiency of the processing that is being executed by the plurality of child apparatuses, and to execute the update processing in an efficient manner.

In the operation of the second embodiment, the update data transmission processing to the child apparatus AR22 is executed upon confirmation that the available processing capacity of the child apparatus AR22 increases up to the level (e.g., “100%”) higher than the predetermined level (e.g., 20%) (upturn). Accordingly, it is possible to reduce the time required for the update data processing to the child apparatus AR22.

Further, in the above example, every time when the type of executed processing (execution state) of the child apparatus AR22 changes, the available processing capacity of the child apparatus AR22 is transmitted to the parent apparatus AR1. Simply put, the available processing capacity notification NT2 is spontaneously transmitted from the child apparatus AR22 to the parent apparatus AR1. Then, in response to the change in the type of executed processing by the apparatus AR22, which is one of the plurality of child apparatuses, the parent apparatus AR1 (specifically, the distribution control unit 15 of this apparatus) obtains the available processing capacity of the one apparatus AR22 as needed from the one apparatus AR22, and determines whether or not the distribution to the one apparatus AR22 is to be executed based on the obtained available processing capacity. Accordingly, it is possible for the parent apparatus AR1 to learn the available processing capacity of the child apparatus AR22 relatively early.

Moreover, this embodiment describes, but not limited to, the example in which the child apparatus notifies the parent apparatus of the available processing capacity of the own apparatus as needed when the type of executed processing of the own apparatus (child apparatus) changes. The child apparatus may notify the parent apparatus of the available processing capacity of this child apparatus as needed, for example, at predetermined timing (e.g., at predetermined time intervals). The child apparatus may notify the parent apparatus of the available processing capacity of the own apparatus (child apparatus) in this manner at one or more time points, such as when the notification request RQ from the parent apparatus is received, when the type of executed processing of the own apparatus (this child apparatus) changes, and when the predetermined timing comes. By notifying the parent apparatus of the available processing capacity of the own apparatus (child apparatus) as needed when the type of executed processing changes, it is possible for the parent apparatus AR1 to learn the available processing capacity of the child apparatus AR22 relatively early, and to Change the distribution operation relatively early.

Furthermore, in the above description, the processing when the available processing capacity of one of the two child apparatuses AR21 and AR22 is lower than the reference value RV1 is described by example. The following describes a case in which the available processing capacities of both of the two child apparatuses AR21 and AR22 take a value lower than the reference value RV1 (e.g., “10%” for both) at one point.

In this case, first, in Step S1613, the parent apparatus AR1 determines that the available processing capacities of both of the child apparatuses AR21 and AR22 are lower than the reference value RV1, and the transmission operation of the update data UD from this parent apparatus AR1 to both of the child apparatuses AR21 and AR22 is suspended.

Thereafter, the change in the type of executed processing is detected for at least one of the plurality of child apparatuses AR21 and AR22, and the available processing capacity notification NT2 is spontaneously transmitted from the at least one apparatus to the parent apparatus AR1. Then, in response to the change in the type of executed processing of the at least one apparatus, the parent apparatus AR1 (specifically, the distribution control unit 15 of this apparatus) obtains the available processing capacity of the at least one apparatus as needed (Step S17), and determines the distribution order to the at least one apparatus as needed based on the obtained available processing capacity (Step S18).

For example, when the available processing capacity of the child apparatus AR21 increases up to “30%” and the available processing capacity of the child apparatus AR22 increases up to “50%”, it is determined that the child apparatus AR21 has a first priority in the distribution order, and the child apparatus AR22 has a second priority in the distribution order (Step S18). Further, either of the available processing capacity “30%” of the child apparatus AR21 and the available processing capacity “50%” of the child apparatus AR22 is determined to be higher than the reference value RV1. Then, the transmission operation of the update data UD from the parent apparatus AR1 to the child apparatus AR21 and the transmission operation of the update data UD from the parent apparatus AR1 to the child apparatus AR22 are executed in this order.

In this manner, the parent apparatus AR1 is able to learn the available processing capacities of the child apparatuses as needed, and to change the distribution operation as needed.

### 3. Third Embodiment

A third embodiment is a modified example of the second embodiment. The following description focuses on differences from the second embodiment.

The third embodiment is different from the first embodiment in that each parent apparatus determines whether or not the transmission operation of the update data UD to the child apparatuses is to be executed based on the available processing capacity of the own apparatus.

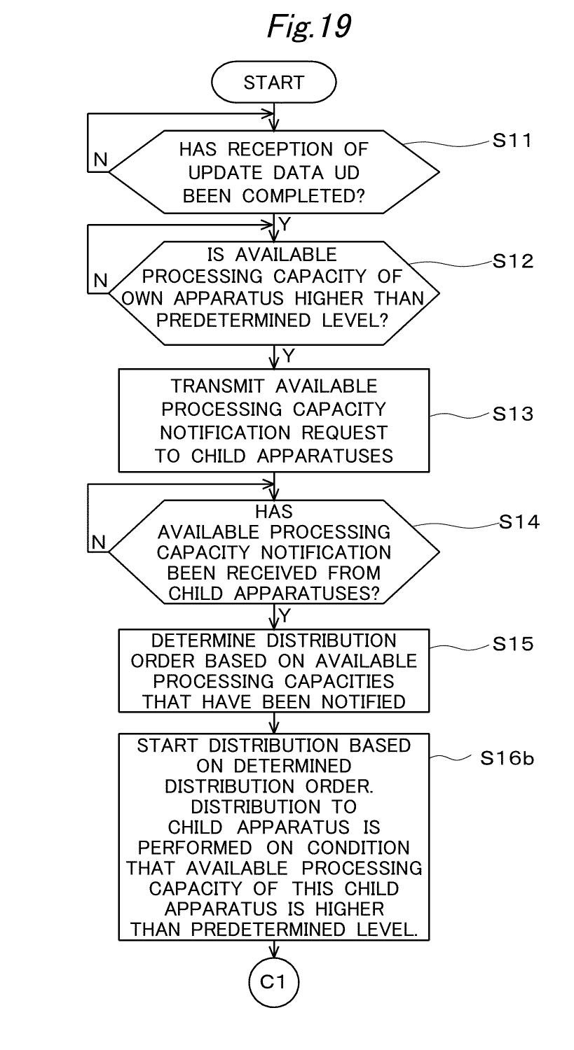

FIG. 19 is a flowchart showing such an operation. In the third embodiment, the processing according to a flowchart shown in FIG. 19 is executed in place of the processing shown in flowchart the in FIG. 14. The flowchart in FIG. 19 is different from the flowchart in FIG. 14 in that it is determined that the available processing capacity of the own apparatus is higher than the predetermined level in Step S12.

More specifically, in Step S12, when the available processing capacity of the own apparatus is lower than a predetermined level (e.g., “20%” (=a reference value RV2)), the process does not proceed to Step S13 and waits until the available processing capacity of the own apparatus reaches the predetermined level. Then, the process proceeds to Step S13 only when the available processing capacity of the own apparatus is determined to be higher than the predetermined reference value RV2. In Step S13 and thereafter, as described above, the transmission processing of the available processing capacity notification request RQ, the reception processing of the available processing capacity notification NT, the determination processing of the distribution order, and the distribute processing (the transmission processing of the update data UD) are executed.

At this time, if the communication processing of the update data UD is further executed when the available processing capacity of the own apparatus (e.g., the parent apparatus AR1) is lower than the predetermined level (e.g., 20%), there is a case in which the processing efficiency of the other processing currently being executed (e.g., print data reception job) decreases. In particular, if the communication processing of the update data UD and the other processing currently being executed use common hardware of various types when the available processing capacity of the own apparatus (parent apparatus) is lower, the processing efficiency often drops to a large degree.

On the other hand, as illustrated in FIG. 19, by the parent apparatus executing the transmission operation of the update data UD to the child apparatuses on condition that the available processing capacity of the own apparatus is higher than the predetermined level, it is possible to prevent a significant drop of efficiency of the processing that is being executed by the parent apparatus.

### 4. Fourth Embodiment

A fourth embodiment is a modified example of the first embodiment. The following description focuses on differences from the first embodiment.

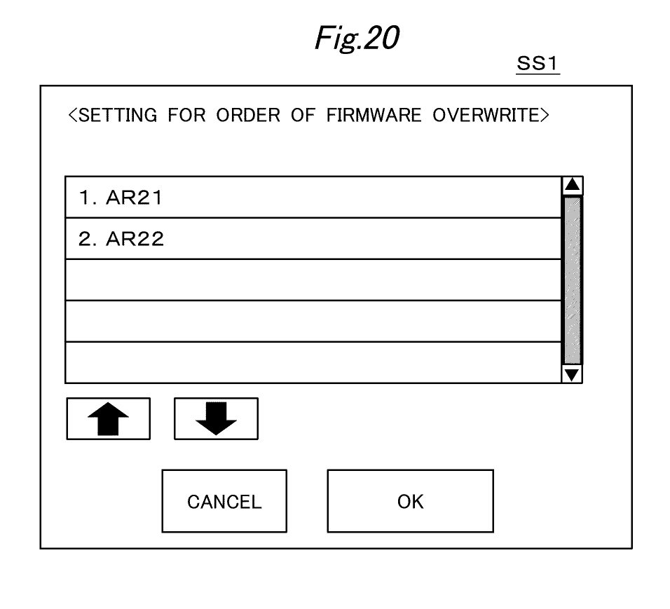

In the fourth embodiment, a prioritized destination apparatus out of the plurality of child apparatuses of the apparatus AR1 is specified manually by a user (such as the administrator) using a setting screen SS1 as illustrated in FIG. 20. The setting screen SS1 is displayed in the operation panel 6c of the apparatus AR1 in response to an operation by an operator. For example, the user is able to set the priority of the child apparatus AR21 to be higher than that of the child apparatus AR22 using the setting screen SS1 of the parent apparatus AR1 as illustrated in FIG. 20.

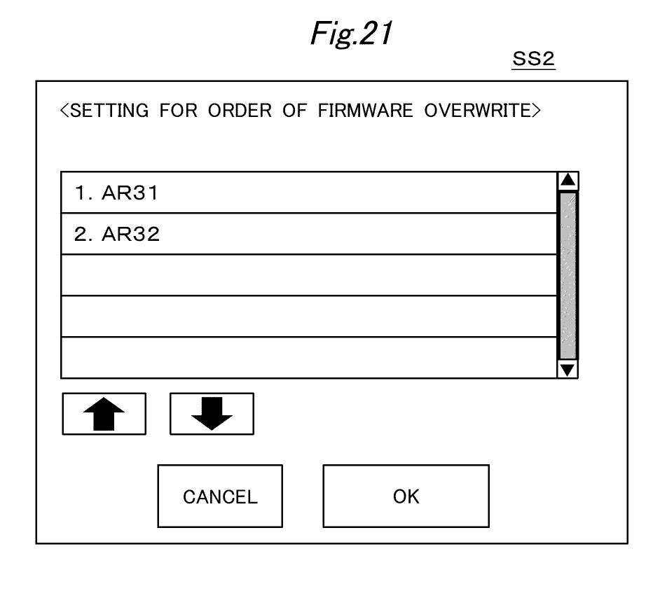

Similarly, a prioritized destination apparatus out of the plurality of child apparatuses of the apparatus AR21 is specified manually by the user (such as administrator) using a setting screen SS2 as illustrated in FIG. 21. The setting screen SS2 is displayed in the operation panel 6c of the apparatus AR21 in response to an operation by the operator. For example, the user is able to set a priority of the child apparatus AR31 to be higher than that of the child apparatus AR32 using the setting screen SS2 of the parent apparatus AR21 as illustrated in FIG. 21.

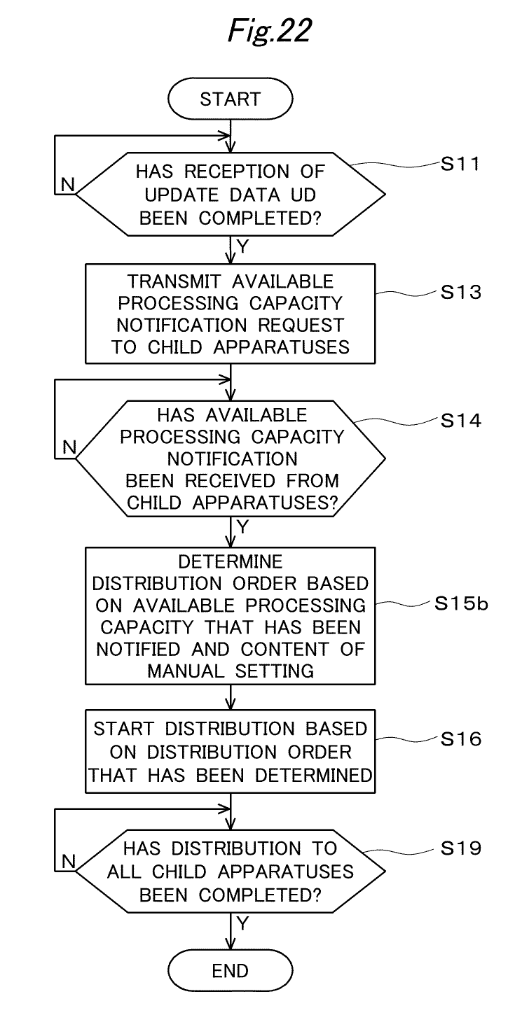

Such a setting operation may be performed by the administrator or the like prior to an operation in FIG. 22.

Thereafter, the operation in FIG. 22 is performed on the parent apparatus AR1. Specifically, in accordance with the priority specified using the setting screen SS1, the distribution order of the update data UD from the parent apparatus AR1 to the plurality of child apparatuses AR21 and AR22 is determined in Step S15 (S15b). In Step S15b, when there is a user instruction made through the setting screen SS, the distribution order regarding the plurality of child apparatuses AR21 and AR22 is determined reflecting this user instruction. For example, if the priority of the child apparatus AR21 is set higher than that of the child apparatus AR22, it is determined that the child apparatus AR21 has a first priority in the distribution order and the child apparatus AR22 has a second priority in the distribution order. Then, the distribution operation to the plurality of child apparatuses AR21 and AR22 is sequentially executed in accordance with the distribution order.

Similarly, the operation in FIG. 22 is performed on the apparatus AR21 on the second level. Specifically, in accordance with the priority specified using the setting screen SS2, the distribution order of the update data UD from the apparatus AR21 (new parent apparatus) to the plurality of child apparatuses AR31 and AR32 is determined in Step S15b. For example, if the priority of the child apparatus AR31 is set higher than that of the child apparatus AR32, it is determined that the child apparatus AR31 has a first priority in the distribution order and the child apparatus AR32 has a second priority in the distribution order. Then, the distribution operation to the plurality of child apparatuses AR31 and AR32 is sequentially executed in accordance with the distribution order.

In this case, the transmission processing of the update data UD from the apparatus AR1 on the first level is preferentially performed to the apparatus AR21 out of the apparatuses AR21 and AR22 on the second level. Further, the transmission processing of the update data UD from the apparatus AR21 on the second level is preferentially performed to the apparatus AR31 out of the apparatuses AR31 and AR32 on the third level.

As for the parent apparatus (e.g., the parent apparatus AR22) for which such a distribution order based on the user operation (distribution order of the plurality of child apparatuses) is not specified, the distribution order is determined based on the available processing capacities of the child apparatuses AR33 and AR34 similarly to the first embodiment.

In the above operation, the distribution order of the update data UD may be flexibly changed by the user's circumstances and the like. For example, if the user wishes to specifically use the apparatuses AR21 and AR31 (in particular, the apparatus AR31) by preferential update, it is possible to distribute the update data UD preferentially to the apparatuses AR21 and AR31 (in particular, the apparatus AR31).

This embodiment describes, but not limited to, the example in which the priority order between both of two child apparatuses is specified on the parent apparatus. Specifically, among three child apparatuses AR33, AR34, and AR35 (see FIG. 13) of the parent apparatus AR22, the priority of the child apparatus AR33 (to have a first priority) may be specified without specifying the priority order between the other two child apparatuses. In this manner, it is possible to, out of N child apparatuses of one parent apparatus, specify a priority order between K child apparatuses (where K<N−1), and not to specify a priority order between the other (N-K) child apparatuses. In this case, the priority order between the K child apparatuses may be determined by the user's instruction, and the priority order between the other (N-K) child apparatuses may be determined based on the available processing capacities of the (N-K) child apparatuses. For example, the priority order of the single child apparatus AR33 may be determined to have a first priority by the user's instruction, and the priority order between the other two child apparatuses AR34 and AR35 may be determined based on the available processing capacities of the two child apparatuses AR34 and AR35.

### 5. Modified Example and Others

The embodiments of the present invention have been described above, but the present invention is not limited to the above examples.

While the MFP is shown as an example of the image forming apparatus 10 in the above embodiments, the present invention is not limited to this example. The idea of the present invention may be applied to an image forming apparatus of various types (printing apparatus, copying apparatus, scanning apparatus, and the like).

Further, the idea of the fourth embodiment may be realized in combination with the idea of the second embodiment and/or the third embodiment.

While the invention has been shown and described in detail, the foregoing description is in all aspects illustrative and not restrictive. It is therefore understood that numerous modifications and variations can be devised without departing from the scope of the invention.

What is claimed is:

1. An image forming apparatus that is one of a large number of image forming apparatuses logically connected in a hierarchical structure of multiple levels, the image forming apparatus comprising:
a state obtaining unit configured to obtain an available processing capacity of each of a plurality of child apparatuses, the plurality of child apparatuses being a plurality of image forming apparatuses on a lower level by one from the image forming apparatus; and
a distribution control unit configured to transmit update data to the plurality of child apparatuses, the update data relating to firmware of apparatuses, wherein
the distribution control unit determines a distribution order relating to the plurality of child apparatuses based on the available processing capacity of each of the plurality of child apparatuses, and transmits the update data to the plurality of child apparatuses in accordance with the distribution order.

2. The image forming apparatus according to claim 1, wherein
the distribution control unit determines one of the plurality of child apparatuses having a highest available processing capacity to be a prioritized destination apparatus, and transmits the update data to the prioritized destination apparatus before a different one of the plurality of child apparatuses.

3. The image forming apparatus according to claim 1, wherein
on condition that an available processing capacity of a specific one of the plurality of child apparatuses is higher than a first reference value, the distribution control unit executes a transmission operation of update data to the specific child apparatus.

4. The image forming apparatus according to claim 1, wherein
on condition that an available processing capacity of the image forming apparatus is higher than a second reference value, the distribution control unit executes a transmission operation of the update data to the plurality of child apparatuses.

5. The image forming apparatus according to claim 1, wherein
in response to a change in a type of executed processing by one child apparatus out of the plurality of child apparatuses, the state obtaining unit obtains an available processing capacity of the one child apparatus from the one child apparatus as needed, and
the distribution control unit determines the distribution order as needed based on the available processing capacity of the one child apparatus obtained by the state obtaining unit.

6. The image forming apparatus according to claim 1, further comprising:
a reception unit configured to receive a user instruction relating to the distribution order, wherein
when there is the user instruction, the distribution control unit determines the distribution order reflecting the user instruction.

7. The image forming apparatus according to claim 1, wherein
the available processing capacity is obtained as an index value corresponding to CPU resources available in each of the plurality of child apparatuses.

8. The image forming apparatus according to claim 1, wherein
the available processing capacity is obtained as an index value corresponding to memory resources available in each of the plurality of child apparatuses.

9. The image forming apparatus according to claim 1, wherein
the available processing capacity is obtained as an index value corresponding to network communication resources available in each of the plurality of child apparatuses.

10. The image forming apparatus according to claim 1, wherein
the available processing capacity is obtained as an index value corresponding to a plurality of elements including at least one of network communication resources, CPU resources, and memory resources available in each of the plurality of child apparatuses.

11. The image forming apparatus according to claim 10, wherein
the available processing capacity is obtained as a value corresponding to a processing capability with a lowest value out of the plurality of index values respectively corresponding to the plurality of elements.

12. The image forming apparatus according to claim 10, wherein
the available processing capacity is obtained as a weighted average efficiency of the plurality of index values respectively corresponding to the plurality of elements.

13. A non-transitory computer readable recording medium having a program recorded therein, the program causing a computer built within an image forming apparatus that is one of a large number of image forming apparatuses logically connected in a hierarchical structure of multiple levels to execute:
(a) a step of obtaining an available processing capacity of each of a plurality of child apparatuses, the plurality of child apparatuses being a plurality of image forming apparatuses on a lower level by one from the image forming apparatus;
(b) a step of determining a distribution order relating to the plurality of child apparatuses based on the available processing capacity of each of the plurality of child apparatuses; and
(c) a step of transmitting update data to the plurality of child apparatuses in accordance with the distribution order.

14. The recording medium according to claim 13, wherein
in the step (b), one of the plurality of child apparatuses having a highest available processing capacity is determined to be a prioritized destination apparatus, and
in the step (c), the update data is transmitted to the prioritized destination apparatus before a different one of the plurality of child apparatuses.

15. The recording medium according to claim 13, wherein
in the step (c), on condition that an available processing capacity of a specific one of the plurality of child apparatuses is higher than a first reference value, a transmission operation of the update data to the specific child apparatus is executed.

16. The recording medium according to claim 13, wherein
in the step (c), on condition that an available processing capacity of the image forming apparatus is higher than a second reference value, a transmission operation of the update data to the plurality of child apparatuses is executed.

17. The recording medium according to claim 13, wherein
in the step (a), in response to a change in a type of executed processing by one child apparatus out of the plurality of child apparatuses, an available processing capacity of the one child apparatus is obtained from the one child apparatus as needed, and
in the step (b), the distribution order is determined as needed based on the available processing capacity of the one child apparatus obtained in the step (a).

18. The recording medium according to claim 13, wherein
the program further causes the computer to execute:
(d) a step of receiving a user instruction relating to the distribution order, wherein
in the step (b), when there is the user instruction, the distribution order is determined reflecting the user instruction.

19. The recording medium according to claim 13, wherein
the available processing capacity is obtained as an index value corresponding to a plurality of elements including at least one of network communication resources, CPU resources, and memory resources available in each of the plurality of child apparatuses.
